(19) United States
(12) Patent Application Publication
(10) Pub. No.: US 2017/0336991 A1
(43) Pub. Date: Nov. 23, 2017

(54) SYSTEM AND METHODOLOGY FOR AUTOMATIC CLASSIFICATION AND SEPARATION OF STORAGE RESOURCES BASED ON OPTIMIZING I/O REQUIREMENTS

(71) Applicant: Knight Point Systems, Inc., Reston, VA (US)

(72) Inventors: Roy Keene, Reston, VA (US); Kenneth Van Alstyne, Reston, VA (US)

(73) Assignee: Knight Point Systems, Inc., Reston, VA (US)

(21) Appl. No.: 15/498,535

(22) Filed: Apr. 27, 2017

Related U.S. Application Data
(60) Provisional application No. 62/328,643, filed on Apr. 28, 2016.

(51) Int. Cl. G06F 3/06; G06F 17/30

(52) U.S. Cl. CPC G06F 3/0613; G06F 3/0629; G06F 17/30312; G06F 3/0611; G06F 3/0689; G06F 3/0659

(57) ABSTRACT

A system and method for classifying storage resources in a cluster of computers comprises one or more memory devices and a plurality of processors. Each memory device among the one or more memory devices stores a set of program modules. At least one processor executes the set of program modules. The set of program modules comprises an input module, a disk speed analyzer module, a disk size analyzer module, and a disk assignment module. The input module receives a first signal. The disk size analyzer module and the disk speed analyzer module determines a data transfer rate and a memory size of the new memory device, and classifies the new memory device. The disk assignment module assigns the new memory device as one of a journal storage unit and a data storage unit.

### FIELD OF THE INVENTION

The present invention relates generally to a system and method for the automatic classification and separation of cloud storage resources based on optimizing input/output requirements, and, more particularly, to a system and method that classifies and assigns data storage types of cloud storage resources based on the resources performance characteristics.

### BACKGROUND OF THE INVENTION

Cluster of computer systems refer to a group of computing devices interconnected via a communications network. As such, cluster computer systems act effectively as a single system with each computer system of the cluster of computer systems assigned tasks, which are scheduled by a software. Cluster computer systems are autonomous systems, but they need to all act together to achieve a common unified goal. The cluster computer systems have a plurality of ports via which several types of storage and memory devices can be connected into the cluster. In traditional environments, the storage devices in the cluster are used as one of a journal storage unit and a data storage unit. When the storage devices are added into the cluster, the storage devices have to be manually configured to be one of the data storage unit and the journal storage unit. Existing systems lack means to automatically configure a new disk after presence of the new disk is detected is found. Further, the existing systems lack means to attach the new disk to a cluster node of an appropriate type, and then reconfigure the cluster accordingly as a whole.

Hence, there is a need for a system and method, for automatically classifying storage resources in a cluster of computers comprises a cluster of computer system device.

### SUMMARY OF THE INVENTION

Accordingly, the present invention is directed to providing a method and apparatus wherein when a new storage resource is added to a network cluster the storage resource is automatically classified and assigned as either a Data storage unit or a Journal storage unit based on the particular performance characteristics of the storage resource being added. To do so, the method and apparatus allows for the cluster node to automatically scan for new disks (memory space). When new disks are found, they are benchmarked and analyzed. Based on the performance characteristics found in the benchmark for the disk's latency, that is, throughput, and the disk's size, it is classified as being either FAST or SLOW, and as either SMALL or LARGE. The system then recognizes each of the four results: FAST, SMALL; FAST, LARGE; SLOW, SMALL; and, SLOW LARGE. Each classification corresponding to an appropriate assignable disk type—that is, Data storage or Journal storage. The CloudSeed™ technological system then assigns all FAST/SMALL disks as journal storage units and all other disks as data disks. If as a result of this there are no journals available then disks are assigned as a combination (data and journal on the same disk).

In one embodiment of the present invention, a system for classifying storage resources in a cluster of computers comprises a cluster of computer system device. The cluster comprises one or more memory devices and a plurality of processors. The one or more memory devices are comprised in one or more computer system devices of the cluster of computer system devices. Each memory device among the one or more memory devices stores a set of program modules. The plurality of processors is comprised in a computer system device of the cluster of computer system devices. At least one processor executes the set of program modules. The set of program modules comprises an input module, a disk speed analyzer module, a disk size analyzer module, and a disk assignment module. The input module receives a first signal, wherein the first signal indicates presence of a new memory device in the cluster. The disk speed analyzer module determines a data transfer rate of the new memory device. Further, the disk speed analyzer classifies the new memory device into one of a first speed classification and a second speed classification, based on the data transfer rate being greater than a user-specified data transfer rate. The disk size analyzer module determines a memory size of the new memory device, and classifies the new memory device into one of a first size classification and a second size classification, based on the memory size being greater than a user-specified data transfer rate. The disk assignment module assigns the new memory device as one of a journal storage unit and a data storage unit based on the new memory device having been classified into at least one of the first size classification, the second size classification, the first speed classification and the second speed classification.

In one embodiment of the present invention the input module receives the first signal from at least one of a user and at least one computer system device in the cluster. The new memory device is at least one of a Random Access Memory device, a cache memory device, a flash memory device, and a magnetic media memory device (such as a hard disk, floppy disk, tape, or the like). Each computer system device in the cluster of computer system device is at least one of a laptop, a server, a network hardware device, a personal computer, and a smart phone, or any combination thereof. Each computer system device in the cluster of computer system device is connected to each other via a network. The network is at least one of a Bluetooth network, a Wi-Fi network, a mobile network, and a WiMax network. The network can also be a wired copper or fiber network as well (e.g., ethernet).

In one embodiment of the present invention, a method of classifying storage resources in a cluster of computers. The method comprises storing in one or more memory devices, a set of program modules. Further, the method comprises receiving by at least one processor, a first signal via an input module, wherein the first signal indicates presence of a new memory device in a cluster of computer system devices. Further, the method determining by the at least one processor via a data speed analyzer module, a data transfer rate of the new memory device. Further, the method classifying by the at least one processor via the data speed analyzer module, the new memory device into one of a first speed classification and a second speed classification, based on the data transfer rate being greater than a user-specified data transfer rate. Further, the method determining by the at least one processor via a data size analyzer module, a memory size of the new memory device. Further, the method classifying the new memory device, by the at least one processor via the data size analyzer module, into one of a first size classification and a second size classification, based on the memory size being greater than a user-specified memory size. Further, the method assigning the new memory device, by the at least one processor via a disk assignment module, as one of a journal storage unit and a data storage unit based on the new memory device being classified into at least one of the first size classification, the second size classification, the first speed classification and the second speed classification.

### BRIEF DESCRIPTION OF DRAWINGS

FIG. 1 illustrates a block diagram of an environment implemented in accordance with various embodiments of the invention.

FIG. 2 illustrates a block diagram of a system for classifying storage nodes in accordance with various embodiments of the invention.

FIG. 3 illustrates a flowchart of a computer implemented method of classifying storage nodes in accordance with various embodiments of the invention.

FIG. 4 illustrates another flowchart of a computer implemented method of automatically classifying and assigning storage types to newly added or discovered data disks (or other memory space) on the cloud based on the discovered data disks performance characteristics, such that the data disk is classified and assigned in the network as a data storage unit or a journal storage unit in accordance with one embodiment of the present invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

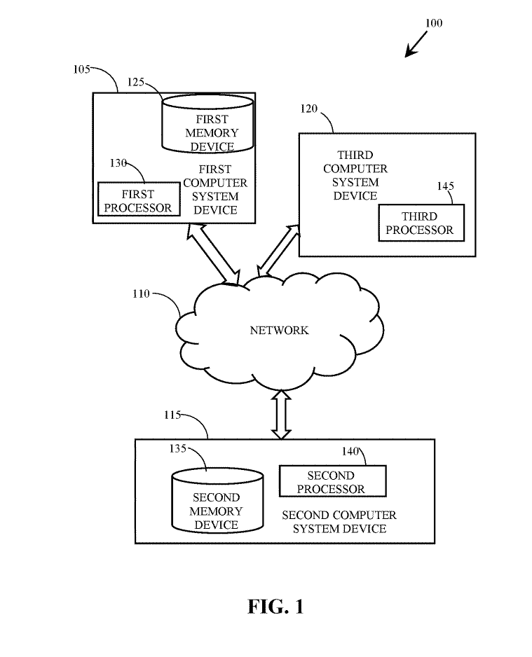

FIG. 1 is a block diagram of an environment 100 in accordance with which various embodiments of the present invention are implemented. The environment 100 comprises a first computer system device 105, a second computer system device 115 and a third computer system device 120. In one example, the first computer system device 105, the second computer system device 115, and the third computer system device 120 are connected as a computer cluster. The first computer system device 105, the second computer system device 115, and the third computer system device 120 are at least one of a laptop, a personal computer, a server, a smart phone, a network hardware device, and a smart television. The network hardware device is at least one of a gateway, a router, a network bridge, a modem, a wireless access point, and a network switch. In another example, the first computer system device 105, the second computer system device 115, and the third computer system device 120 are gateways to at least one of a wide area network, a local area network, and internet. The first computer system device 105, the second computer system device 115, and the third computer system device 120 are connected via a network 110. The network 110 is at least one of a mobile network, a wide area network, a local area network, and internet. The first computer system device 105 comprises a first memory device 125 and a first processor 130. The second computer system device 115 comprises a second memory device 135, and a second processor 140. The third computer system device 120 comprises a third processor 145. In one embodiment of the present invention, the computer cluster comprising the first computer system device 105, the second computer system device 115, and the third computer system device 120 hosts a system for classifying a storage resource in the cluster. In one example, the storage resource is at least one of the first memory device 125, and the second memory device 135.

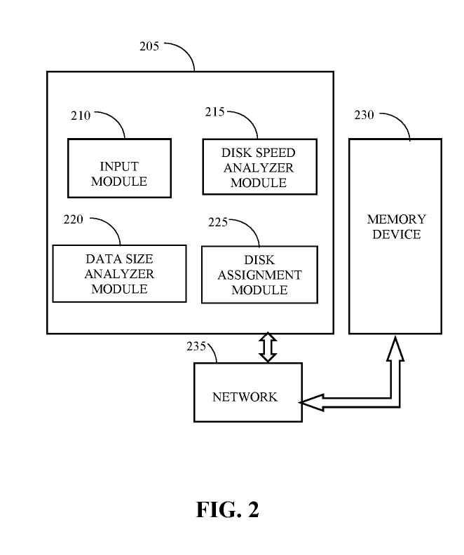

At least one of the first memory device 125 and the second memory device 135 stores a set of program modules. The set of program modules comprises an input module, a disk speed analyzer module, a disk size analyzer module, and a disk assignment module. At least one processor among the first processor 130, the second processor 140, and the third processor 145 executes the set of program modules. The at least one processor executes the set of program modules. In one example, the set of program modules are executed by a combination of multiple processors among the first processor 130, the second processor 140, and the third processor 145. FIG. 2 is a block diagram of a system for implementing optimized data replication across cloud storage nodes according to one example of functioning of the present invention.

Referring to FIG. 2, in one example, a cluster of computer system devices comprises one or more memory devices and a plurality of processors. Each computer system device in the cluster of computer system device is at least one of a laptop, a server, a network hardware device, a personal computer, and a smart phone, or any combination thereof. Each computer system device in the cluster of computer system device is connected to each other via a network 235. The network 235 is at least one of a Bluetooth network, a Wi-Fi network, a mobile network, and a WiMax network. The network 235 can also be a wired copper or fiber network as well (e.g., ethernet).

The one or more memory devices are comprised in one or more computer system devices of the cluster of computer system devices. A memory device (not shown) among the one or more memory devices stores a set of program modules. The set of program modules comprises an input module 210, a disk speed analyzer module 215, a disk size analyzer module 220, and a disk assignment module 225. A processor 205 among the plurality of processors is comprised in a computer system device of the cluster of computer system devices. The processor 205 executes the set of program modules. The input module 210 receives a first signal, wherein the first signal indicates presence of a new memory device 230 in the cluster. In one embodiment of the present invention the input module 210 receives the first signal from at least one of a user and at least one computer system device in the cluster. The new memory device 230 is at least one of a Random-Access Memory device, a cache memory device, a flash memory device, and a magnetic media memory device (such as a hard disk, floppy disk, tape, or the like).

The disk speed analyzer module 215 determines a data transfer rate of the new memory device. Further, the disk speed analyzer module 215 classifies the new memory device 230 into one of a first speed classification and a second speed classification, based on the data transfer rate being greater than a user-specified data transfer rate. In one example, memory devices classified into the first speed classification are hereafter referred to as FAST disks, and the memory devices classified into the second speed classification are hereafter referred to as SLOW disks. In another example, the input module 210 receives the user-specified data transfer rate from the at least one user. In one example, the user-specified data transfer rate is 6400 MB/s. In one example, the new memory device 230 is classified as the FAST disk if the data transfer rate of the new memory device 230 is greater than 6400 MB/s.

The disk size analyzer module 220 determines a memory size of the new memory device 230, and classifies the new memory device 230 into one of a first size classification and a second size classification, based on the memory size being greater than a user-specified data transfer rate. In one example, memory devices classified into the first size classification are hereafter referred to as LARGE disks, and the memory devices classified into the second size classification are hereafter referred to as SMALL disks. In another example, the input module 210 receives the user-specified memory size from the at least one user. In one example, the user-specified memory size is 64 Gigabytes. In one example, the new memory device 230 is classified as the LARGE disk if the memory size of the new memory device 230 is greater than 64 Gigabytes.

The disk assignment module 225 assigns the new memory device 230 as one of a journal storage unit and a data storage unit based on the new memory device 230 having been classified into at least one of the first size classification, the second size classification, the first speed classification and the second speed classification. In one example, if the new memory device 230 is a SMALL disk and a FAST disk, then the new memory device 230 is classified as a journal storage disk.

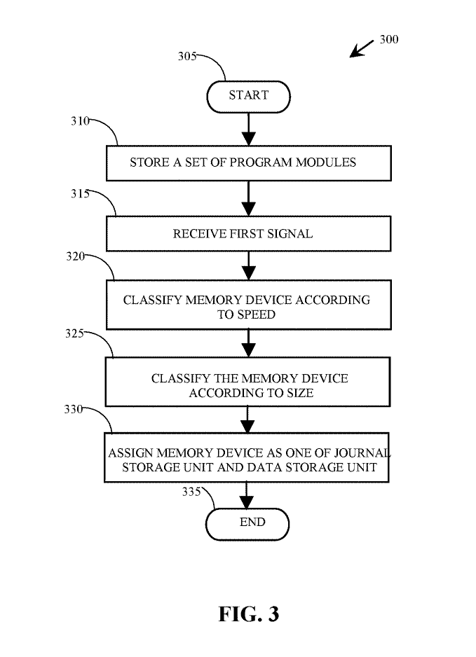

Referring to FIG. 3, in one example, a method 300 of classifying storage resources in a cluster of computer system devices comprises one or more memory devices and a plurality of processors. Each computer system device in the cluster of computer system device is at least one of a laptop, a server, a network hardware device, a personal computer, and a smart phone, or any combination thereof. Each computer system device in the cluster of computer system device is connected to each other via a network. The network is at least one of a Bluetooth network, a Wi-Fi network, a mobile network, and a WiMax network. The one or more memory devices are comprised in one or more computer system devices of the cluster of computer system devices. The method 300 commences at step 305.

At step 310 at least one memory device (not shown) among the one or more memory devices stores a set of program modules. The set of program modules comprises an input module, a disk speed analyzer module, a disk size analyzer module, and a disk assignment module. A processor among the plurality of processors is comprised in a computer system device of the cluster of computer system devices. The processor executes the set of program modules.

At step 315, the input module receives a first signal, wherein the first signal indicates presence of a new memory device in the cluster. In one embodiment of the present invention the input module receives the first signal from at least one of a user and at least one computer system device in the cluster. The new memory device is at least one of a Random-Access Memory device, a cache memory device, a flash memory device, and a magnetic media memory device (such as a hard disk, floppy disk, tape, or the like).

At step 320, the disk speed analyzer module classifies the new memory device according to speed of the new memory device. To classify the new memory device, the disk speed analyzer module determines a data transfer rate of the new memory device. Further, the disk speed analyzer module classifies the new memory device into one of a first speed classification and a second speed classification, based on the data transfer rate being greater than a user-specified data transfer rate. In one example, memory devices classified into the first speed classification are hereafter referred to as FAST disks, and the memory devices classified into the second speed classification are hereafter referred to as SLOW disks. In another example, the input module receives the user-specified data transfer rate from the at least one user. In one example, the user-specified data transfer rate is 6400 MB/s. In one example, the new memory device is classified as the FAST disk if the data transfer rate of the new memory device is greater than 6400 MB/s.

At step 325, the disk size analyzer module classifies the new memory device according to a memory size of the new memory device. To classify the new memory device, the disk size analyzer module determines a memory size of the new memory device. Further, the disk size analyzer module classifies the new memory device into one of a first size classification and a second size classification, based on the memory size being greater than a user-specified data transfer rate. In one example, memory devices classified into the first size classification are hereafter referred to as LARGE disks, and the memory devices classified into the second size classification are hereafter referred to as SMALL disks. In another example, the input module receives the user-specified memory size from the at least one user. In one example, the user-specified memory size is 64 Gigabytes. In one example, the new memory device is classified as the LARGE disk if the memory size of the new memory device is greater than 64 Gigabytes.

At step 330, the disk assignment module assigns the new memory device as one of a journal storage unit and a data storage unit based on the new memory device having been classified into at least one of the first size classification, the second size classification, the first speed classification and the second speed classification. In one example, if the new memory device is a SMALL disk and a FAST disk, then the new memory device is classified as a journal storage disk.

The method 300 ends at step 335.

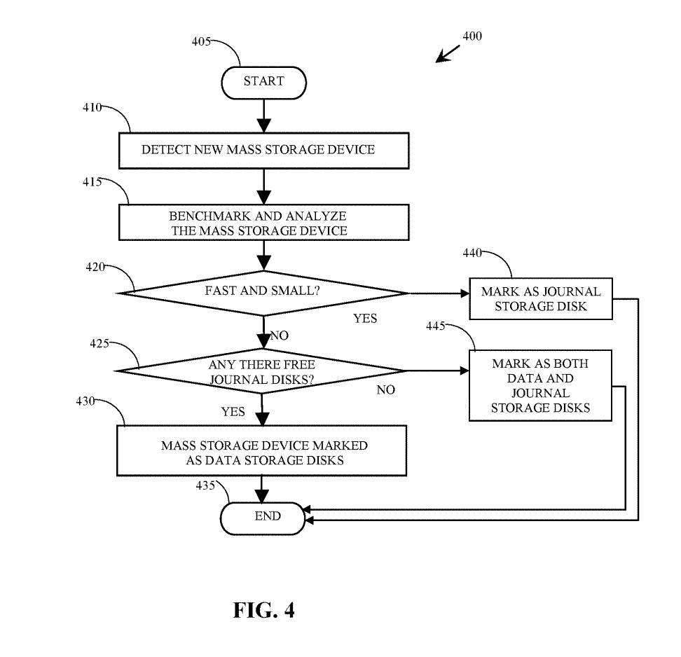

FIG. 4 illustrates a method 400 for automatically classifying and assigning storage types to newly added or discovered data disks (or other memory space) on the cloud based on the discovered data disks performance characteristics, such that the data disk is classified and assigned in the network as a data storage unit or a journal storage unit. As is well known in the art, data storage units are for permanent storage of data (until, of course, such data is erased) on a network cloud, while journal storage units are for the temporary storage of such data until written to the more permanent data storage units. Journal storage units are utilized for the quicker download and/or write performance characteristics such data disk (or other type of memory space) have, thereby optimizing the input/output capabilities of the network system. Data is written to such journal data storage units only until such time as the data is written to the data storage units and then such memory/data space is cleared.

Referring now specifically to FIG. 4, the steps of the automatic classification and assignment methodology 1 for new storage units are shown. The network/cloud system (not shown) waits for the addition of the new storage units/devices. It is to be understood, of course, that several types of storage units/devices may be added. Accordingly, an administrator adds the new storage device. It is to be understood, of course, that such addition may take various forms. For instance, a new data storage disk may be plugged into the system by an administrator, or a storage data disk that was taken off-line for repair may be re-added. The method 400 begins at step 405.

In step 410 the network/cloud system detects the addition of the storage unit/device.

Once a new storage unit has been identified, two steps are performed by the system in parallel. In step 415, the system benchmarks the new storage device by its performance characteristics of whether it is fast or slow. In other words, can data be written and/or downloaded quickly or slowly. Further, in step 415, the system analyzes the storage device as to its size, that is whether it is large or small. in other words, how much data can be safely written to the storage device, either a large or small quantity. Furthermore, in step 415, the system quantifies the storage unit based on the performance characteristics and the size of the new storage device.

In step 420, based on the quantifiable calculation performed, the system first attempts to classify the storage unit/device. If the storage unit/device has been identified as a “fast & small” unit/device, then in step 440 the unit/device is marked as a Journal disk. If, however, the unit/device has been identified as one of the other types, that is “fast & large”, “slow & large”, or “slow & small”, then the system moves to step 425.

In step 425, the system determines whether there are any free journal disks, and, if not, in step 445 the unit/device is marked as a combined Journal and Data disk. If, on the other hand, the system determines that there are free journal disks, then in step 430, the unit/device is marked as a Data disk.

Further, the existing Journal disks are marked as to be used for the newly added Data unit/device. Depending on the classification of the unite/device, the newly added storage unit/device is formatted by the system as it has been marked. Furthermore, the new storage unit/device is added to the storage capabilities of the network/cloud. Lastly, the system resumes wait for possible additions of storage units/devices.

The method 400 ends at step 435.

The foregoing description comprises illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A system for classifying storage resources in a cluster of computers, the system comprising:
a cluster of computer system devices;
one or more memory devices, comprised in one or more computer system devices of the cluster of computer system devices, wherein each memory device among the one or more memory devices stores:
a set of program modules;
a plurality of processors, a processor among the plurality of processor being comprised in a computer system device of the cluster of computer system devices, wherein at least one processor executes the set of program modules, the set of program modules comprising:
an input module, executed by the at least one processor, configured to receive a first signal, wherein the first signal indicates presence of a new memory device in the cluster;
a disk speed analyzer module, executed by the at least one processor, configured to:
determine a data transfer rate of the new memory device, and
classify the new memory device into one of a first speed classification and a second speed classification, based on the data transfer rate being greater than a user-specified data transfer rate;
a disk size analyzer module, executed by the at least one processor, configured to:
determine a memory size of the new memory device, and
classify the new memory device into one of a first size classification and a second size classification, based on the memory size being greater than a user-specified data transfer rate; and
a disk assignment module, executed by the at least one processor to assign the new memory device as one of a journal storage unit and a data storage unit based on the new memory device having been classified into at least one of the first size classification, the second size classification, the first speed classification and the second speed classification.

2. The system of claim 1, wherein the input module receives the first signal from at least one of a user and at least one computer system device in the cluster.

3. The system of claim 1, wherein the new memory device is at least one of a Random-Access Memory device, a cache memory device, a flash memory device, and a magnetic media memory device (such as a hard disk, floppy disk, tape, or the like).

4. The system of claim 1, wherein each computer system device in the cluster of computer system device is at least one of a laptop, a server, a network hardware device, a personal computer, and a smart phone, or any combination thereof.

5. The system of claim 1, wherein each computer system device in the cluster of computer system device is connected to each other via a network.

6. The system of claim 5, wherein the network is at least one of a Bluetooth network, a Wi-Fi network, a mobile network, and a WiMax network.

7. A method of classifying storage resources in a cluster of computers, the method comprising:
storing in one or more memory devices, a set of program modules;
receiving by at least one processor, a first signal via an input module, wherein the first signal indicates presence of a new memory device in a cluster of computer system devices;
determining by the at least one processor via a data speed analyzer module, a data transfer rate of the new memory device;
classifying by the at least one processor via the data speed analyzer module, the new memory device into one of a first speed classification and a second speed classification, based on the data transfer rate being greater than a user-specified data transfer rate;
determining by the at least one processor via a data size analyzer module, a memory size of the new memory device;
classifying the new memory device, by the at least one processor via the data size analyzer module, into one of a first size classification and a second size classification, based on the memory size being greater than a user-specified memory size; and
assigning the new memory device, by the at least one processor via a disk assignment module, as one of a journal storage unit and a data storage unit based on the new memory device being classified into at least one of the first size classification, the second size classification, the first speed classification and the second speed classification.

8. The method of claim 7, wherein the input module receives the first signal from at least one of a user and at least one computer system device in the cluster.

9. The method of claim 7, wherein the new memory device is at least one of a Random-Access Memory device, a cache memory device, a flash memory device, and a magnetic media memory device (such as a hard disk, floppy disk, tape, or the like).

10. The method of claim 7, wherein each computer system device in the cluster of computer system device is at least one of a laptop, a server, a network hardware device, a personal computer, and a smart phone, or any combination thereof.

11. The method of claim 7, wherein each computer system device in the cluster of computer system device is connected to each other via a network.

12. The method of claim 11, wherein the network is at least one of a Bluetooth network, a Wi-Fi network, a mobile network, and a WiMax network.
